(19) United States
(12) Patent Application Publication
(10) Pub. No.: US 2005/0133652 A1
(43) Pub. Date: Jun. 23, 2005

(54) Belt retractor for a vehicle safety belt

(75) Inventor: Thomas Kielwein, Eschach (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive GmbH

(21) Appl. No.: 11/013,563

(22) Filed: Dec. 16, 2004

(30) Foreign Application Priority Data
Dec. 19, 2003 (DE) 103 60 032.9

(51) Int. Cl. B60R 22/405; B60R 22/41

(52) U.S. Cl. 242/383.4; 242/384.6

(57) ABSTRACT

A belt retractor for a vehicle safety belt has a frame, a belt spool which can receive a safety belt and is rotatably arranged in the frame, and a blocking mechanism by means of which the belt spool can be blocked against a rotation in the safety belt unwinding direction relative to the frame. The blocking mechanism contains a coupling disc which is rotatable relative to the belt spool. A locking mechanism is provided which locks a response of the blocking mechanism in a function range in which almost the entire safety belt is wound on the belt spool.

The invention relates to a belt retractor for a vehicle safety belt, with a frame, a belt spool which can receive a safety belt and is arranged rotatably in the frame, and with a blocking mechanism by means of which the belt spool can be blocked against a rotation in the safety belt unwinding direction relative to the frame, the blocking mechanism containing a coupling disc which is rotatable relative to the belt spool.

### BACKGROUND OF THE INVENTION

The blocking mechanism serves in a known manner to block the belt spool in a vehicle-sensitive or belt band-sensitive manner. A vehicle-sensitive blocking is triggered when the accelerations acting on the vehicle and therefore also on the belt retractor, which is mounted therein, exceed a specified value. A belt band-sensitive blocking is triggered when the rotary acceleration of the belt spool, brought about by a rapid withdrawal of the safety belt from the belt spool, exceeds a specified value. In both cases, the blocking is triggered in that a relative rotation occurs between the coupling disc and the belt spool, which is then used to guide a blocking catch into blocking teeth.

With the vehicle-sensitive blocking, a sensor is used which, on exceeding the specified acceleration, blocks the coupling disc. If, in this state, safety belt is withdrawn from the belt spool, the coupling disc—because it is secured by the sensor—lags behind the rotation of the belt spool, so that the necessary relative rotation is obtained for guiding the blocking catch. With the belt band-sensitive blocking, the mass moment of inertia of the coupling disc is used to bring about the relative rotation; with a sufficiently high rotary acceleration of the belt spool, the coupling disc lags behind the rotation of the belt spool, whereby the blocking catch can be guided in.

The blocking mechanism, however, also possibly responds in situations in which this is not desired. In particular with the rapid winding of the belt band, for example when a vehicle occupant has taken off the safety belt and the safety belt is rolled up under the action of a winding spring, it can occur that the blocking mechanism responds. This is the case in particular when the safety belt is braked abruptly, for example when an insert tongue, situated on the safety belt, butts against another component or the safety belt is fully wound, whereby the belt spool is braked abruptly. Through the abrupt braking, a relative rotation can occur between the coupling disc and the belt spool, so that the blocking mechanism responds. In addition, the risk exists that through vibrations, the sensor on the belt retractor responds, whereby a vehicle-sensitive blocking can be triggered.

If belt band is then to be withdrawn from the belt spool, the belt spool is blocked by the blocking mechanism. A vehicle occupant could therefore gain the impression that the belt retractor is defective. The blocking of the belt spool can then only be released by pulling firmly on the safety belt, so that through the film spool effect a small length of safety belt can be withdrawn. In the subsequent freeing of the safety belt, the belt spool is turned back slightly, whereby the blocking mechanism is unlocked.

Various precautions are known from the prior art, in order to prevent the undesired blocking of the belt spool at the end of the winding movement. These precautions, however, do not always work satisfactorily; this applies both to their function and also to the effort.

The object of the invention consists in further developing a belt retractor of the type initially mentioned to the effect that an undesired blocking of the belt spool at the end of the winding of the safety belt is reliably prevented.

### BRIEF DESCRIPTION OF THE INVENTION

To solve this problem, in a belt retractor of the type initially mentioned in accordance with the invention a locking mechanism is provided which locks a response of the blocking mechanism in a function range in which almost the entire safety belt is wound on the belt spool. The locking mechanism here can neutralize the vehicle-sensitive blocking and/or the belt band-sensitive blocking of the belt spool in line with specific objectives.

According to a preferred embodiment of the invention, provision is made that the blocking mechanism has a vehicle-sensitive sensor with a sensor lever, which can engage on the coupling disc, and that the locking mechanism, when it is activated, locks the sensor lever so that the latter can not engage on the coupling disc. In this way, it is reliably prevented that the vehicle-sensitive sensor responds and thereby blocks the coupling disc, which could lead to a vehicle-sensitive blocking of the belt spool.

According to a preferred embodiment of the invention, provision is made that the locking mechanism, when it is activated, locks the coupling disc so as to be secure with regard to rotation with respect to the belt spool. This prevents a relative rotation between the coupling disc and the belt spool, so that any response of the blocking mechanism is reliably prevented. In particular, a belt band-sensitive response is not possible, because also with an abrupt acceleration or deceleration of the belt spool, the coupling disc is directly entrained, so that no relative rotation is possible between the coupling disc and the belt spool and accordingly also no response of the blocking mechanism is possible.

Advantageous developments of the invention will be apparent from the sub-claims.

### BRIEF DESCRIPTION OF THE DRAWINGS

The invention is described below with the aid of a preferred embodiment which is illustrated in the enclosed drawings. In these:

FIG. 1 shows a diagrammatic side view of a belt retractor;

FIG. 2 shows in a perspective side view the blocking mechanism of the belt retractor of FIG. 1;

FIG. 3 shows in a further perspective side view the blocking mechanism, the coupling disc having been omitted, for better clarity;

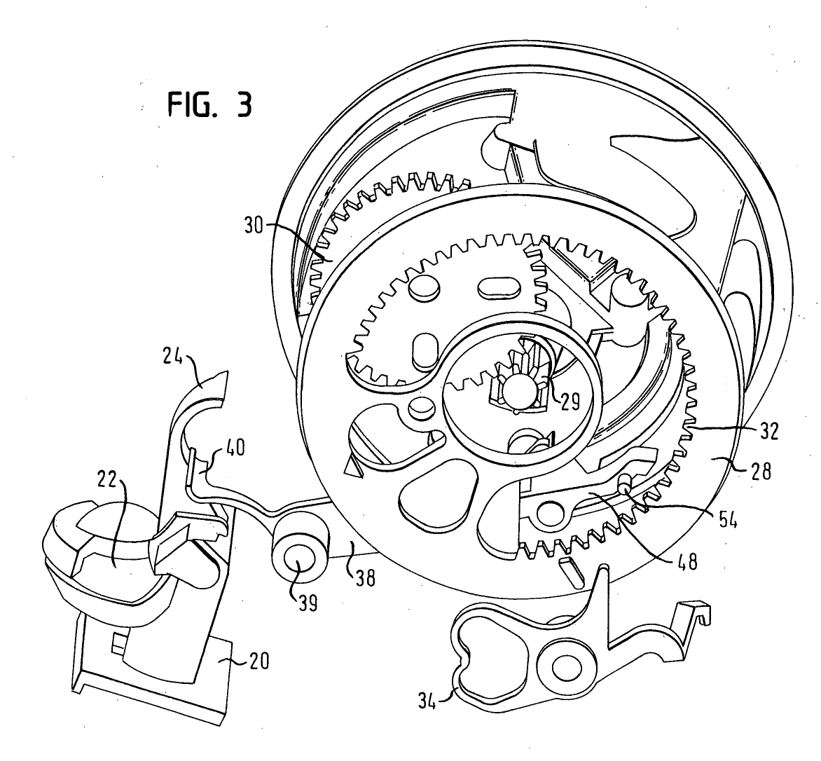

FIG. 4 shows in a further perspective side view the blocking mechanism, the coupling disc likewise having been omitted;

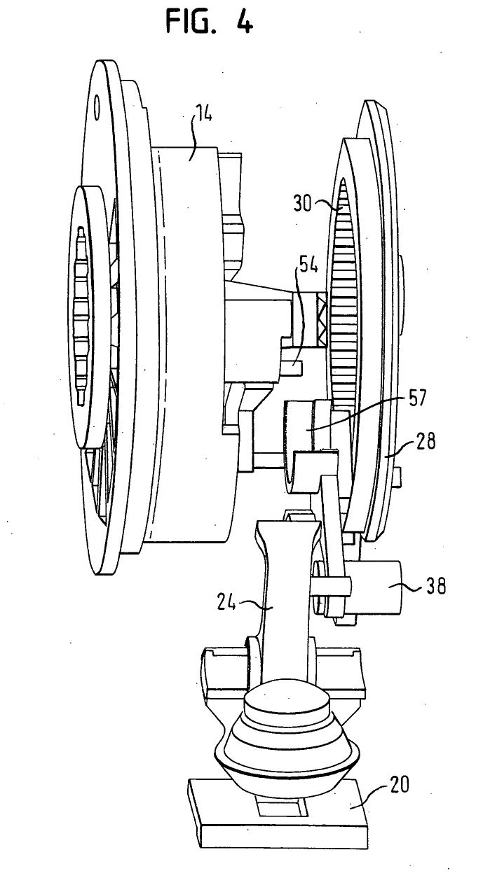

FIG. 5 shows in a perspective side view the components which are necessary for blocking the sensor lever;

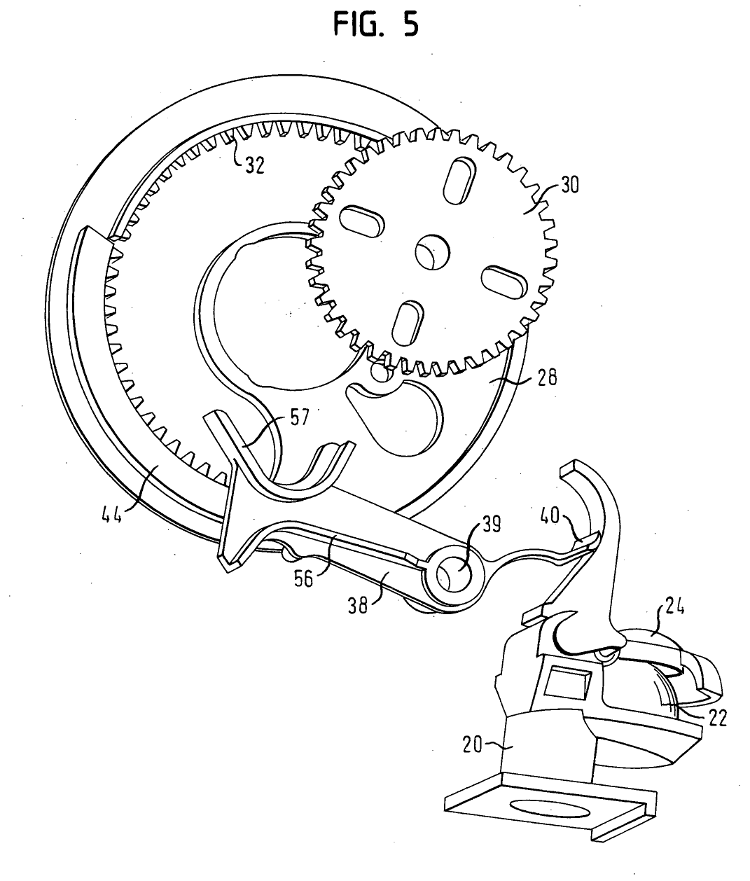

FIG. 6 shows a perspective view of the locking lever shown in FIG. 5;

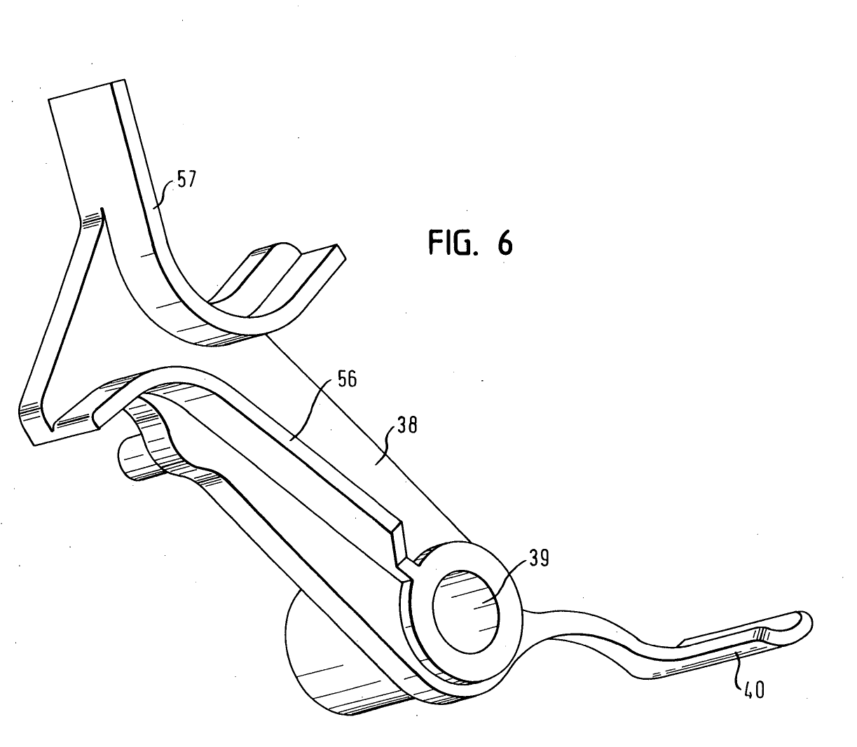

FIG. 7 shows another side view of the locking lever;

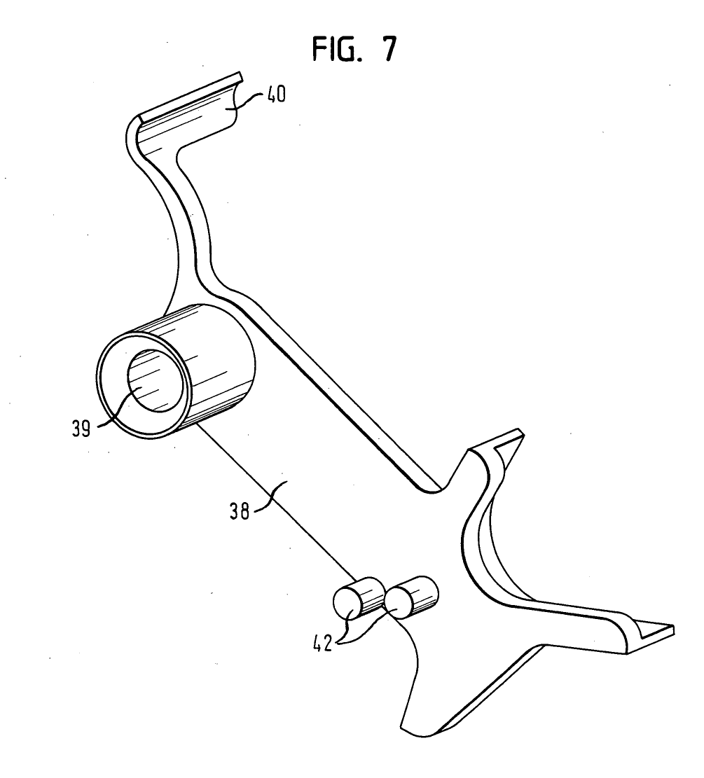

FIG. 8 shows in a perspective view one end of the belt spool;

FIG. 9 shows in a diagrammatic side view the blocking mechanism, the locking disc having been omitted for better clarity,

FIG. 10 shows in a perspective side view the coupling disc arranged on the belt spool;

Figure 11 shows a detail of the locking mechanism, the locking lever being situated in the initial position; and

FIG. 12 shows the locking mechanism in a diagrammatic view, the locking lever being in the locking position.

### DETAILED DESCIPTION OF THE INVENTION

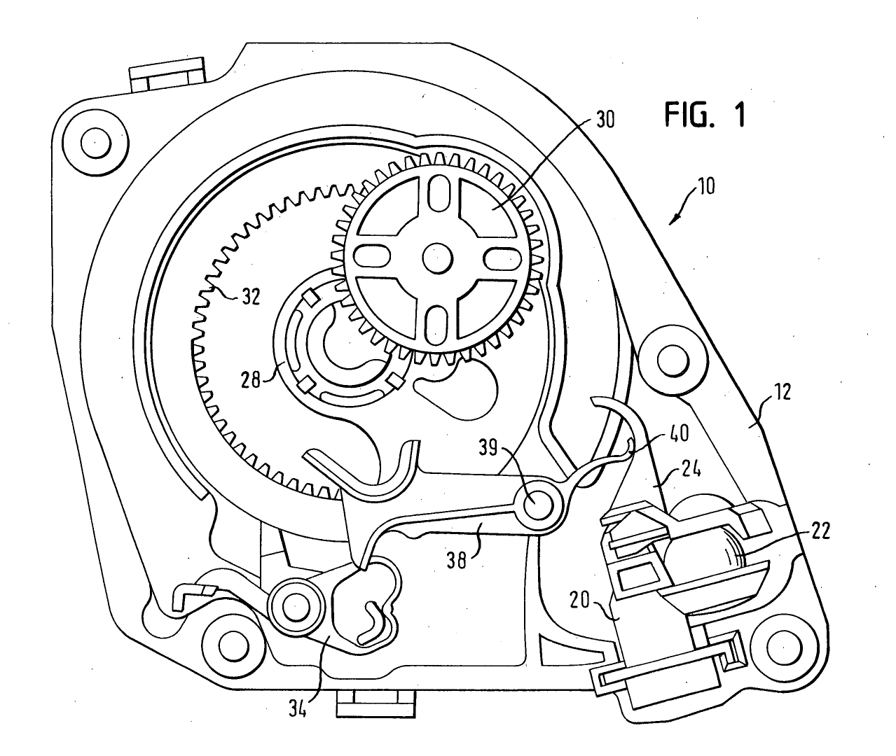

In FIG. 1 a belt retractor 10 is shown, which has a frame 12 in which a belt spool 14 is rotatably mounted. Only an end face of this can be seen in the figures. This end face can be constructed in one piece with the belt spool, or else as a separate component.

A blocking mechanism is provided, which serves to block the belt spool so as to be secure with regard to rotation relative to the frame 12 in case of necessity. The details of the structure and mode of operation of the blocking mechanism are described below only in so far as they are necessary for an understanding of the invention. An essential component of the blocking mechanism is a coupling disc 16, which is arranged coaxially with the belt spool and is rotatable relative thereto to a limited extent. Through a relative rotation between the coupling disc 16 and the belt spool 14, a blocking catch (not illustrated), which is arranged in a recess 18 on the end face of the belt spool 14, is guided into blocking teeth on the frame 12 of the belt retractor 10. Such a relative rotation can be brought about in a belt band-sensitive manner or in a vehicle-sensitive manner. For a vehicle-sensitive controlling of the blocking mechanism, a sensor 20 is arranged on the frame of the belt retractor, which has a sensor ball 22 and a sensor lever 24. The sensor lever 24 can be guided into teeth 26 of the coupling disc 16, so that the coupling disc 16 is blocked against a rotation in the unwinding direction of the safety belt. When the safety belt is withdrawn from the belt spool, the coupling disc 16 remains at a standstill. The relative rotation resulting therefrom between the belt spool and the coupling disc is used to control the blocking catch.

A locking disc 28 is provided, which is likewise arranged concentrically with the belt spool. The locking disc 28 is mounted rotatably on a housing part (not illustrated), which is arranged on the frame 12 of the belt retractor 10. The locking disc 12 is connected with the belt spool 14 by a reduction, which consists of a pinion 29 constructed on the belt spool 14, a two-stage reduction gear wheel 30, which is mounted so as to be stationary with respect to the frame 12 of the belt retractor, and of inner teeth 32 which are constructed on the locking disc 28 and extend over approximately 270 degrees. The reduction reduces the rotation of the belt spool 14 to such a great extent that the locking disc 28 carries out a rotation of a maximum of 270 degrees between a state of the belt retractor with fully wound safety belt on the one hand and with fully unwound safety belt on the other hand.

A child safety lever 34 is provided, by means of which a child safety function can be achieved. When the child safety function is activated, no belt band can be unwound from the belt retractor; it is merely possible to wind the belt band. Such a function is desirable, for example, in order to fix a child's seat securely to the vehicle seat. The child safety function is realized in a manner known per se by two trip cams 36, 37 on the locking disc 28, which as a function of the position of the locking disc 28 can adjust the child safety lever between an initial position in which it does not engage on the teeth 26 of the coupling disc 16, and an activated position in which it blocks the coupling disc 16, so that on withdrawal of the safety belt a belt band-sensitive blocking is triggered immediately. The two trip cams 36, 37 are arranged here so that the child safety function is activated by almost complete withdrawal of the safety belt from the belt spool and is deactivated again by almost complete winding of the safety belt.

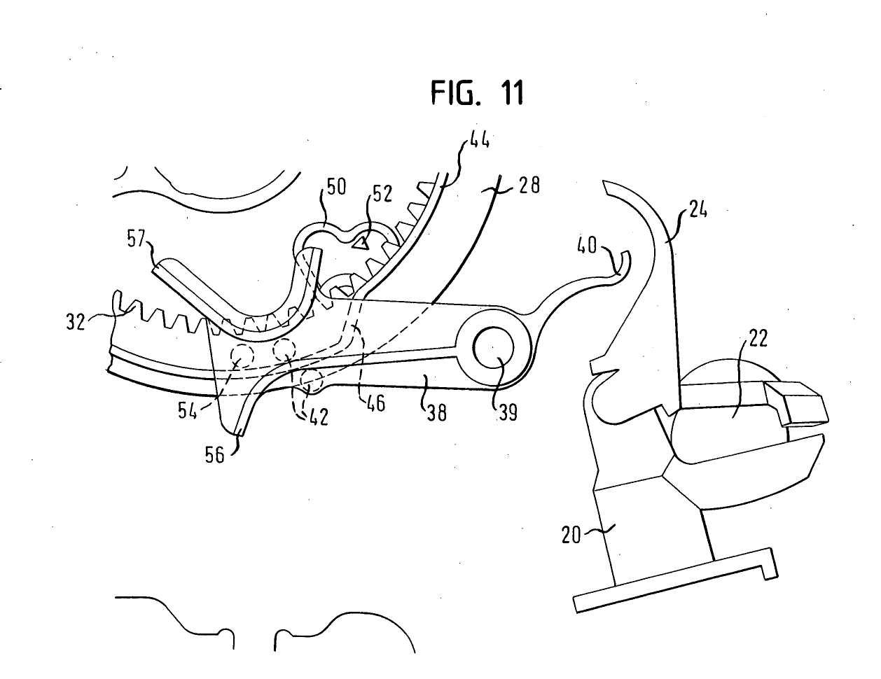

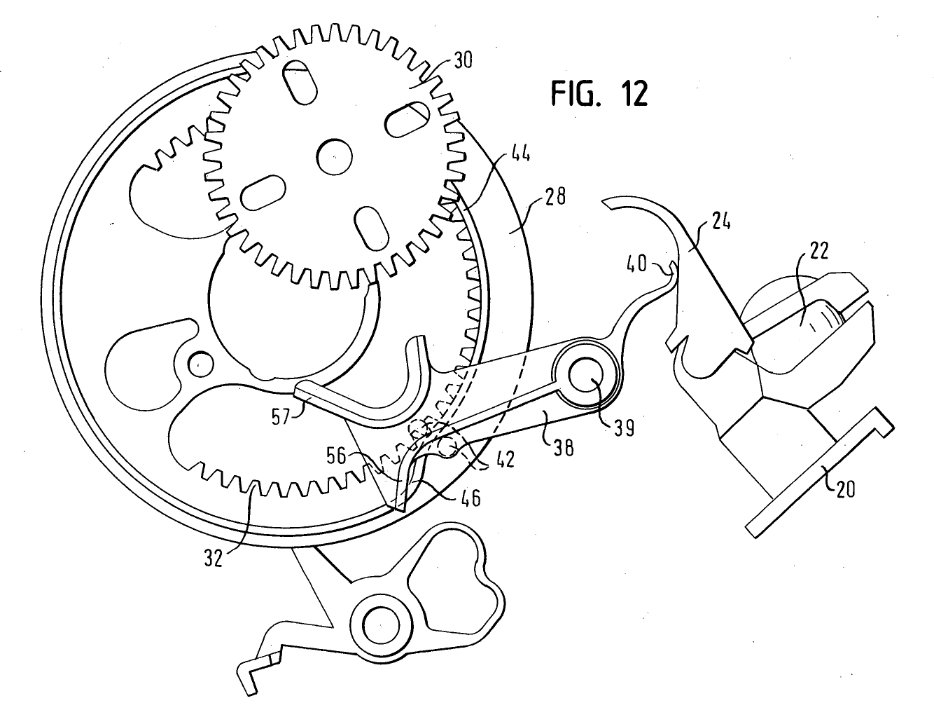

A locking mechanism is provided, by means of which, as a function of the position of the locking disc 28, the response of the blocking mechanism can be prevented. The locking mechanism contains, on the one hand, a locking lever 38, which is arranged in fixed position relative to the frame 12 of the belt retractor and is able to be swivelled between two positions about a bearing 39, namely an initial position (see FIG. 11) and a locking position (see FIG. 12). The locking lever 38 has a locking extension 40, which can cooperate with the sensor lever 24. When the locking lever 38 is situated in its initial position, the locking extension 40 lies at such a great distance from the sensor lever 24 (see FIG. 11) that the sensor lever 24 can be guided into the teeth 26 of the coupling disc 16. When the locking lever 38, on the other hand, is situated in its locking position, the locking extension 40, on the other hand, lies against the sensor lever 24 and presses it away from the coupling disc 16, so that a guiding in is reliably prevented. An inadvertent response of the sensor 20, for example by vibrations on winding of the safety belt, is reliably prevented in this way. An inadvertent blocking of the belt spool can not occur. By utilizing the inherent elasticity of the locking extension 40, the entire sensor 20 can be pre-stressed elastically into its initial position, in which the sensor lever 24 and the sensor ball 22 are placed at rest. A rattling is reliably prevented.

On the side facing away from the locking extension, the locking lever 38 is provided with two guide pins 42, which together with a guide rib 44 form a connecting link guide on the locking disc 28. The guide rib 44 extends along the periphery of the locking disc 28 and consists of a section arranged radially further outwards and of a section arranged radially further inwards. Between these two sections, a transition section 46 is arranged (see in particular FIGS. 11 and 12). The two sections of the guide rib 44 together with the transition section 46 are arranged on the locking disc 28 so that the locking lever 38 is held in the locking position by cooperation of the guide pins 42 with the section of the guide rib 44 lying further inwards, when almost the entire safety belt is wound on the belt spool 14. As soon as a comparatively small length of safety belt is unwound, the locking lever 38 is swivelled from the transition section 46 into the position shown in FIG. 11, so that the sensor lever 24 is freed and a normal vehicle-sensitive blocking is possible. As soon as the safety belt is almost completely wound again, the locking lever 38 is transferred back into the locking position shown in FIG. 12, in which an inadvertent response of the blocking mechanism is prevented.

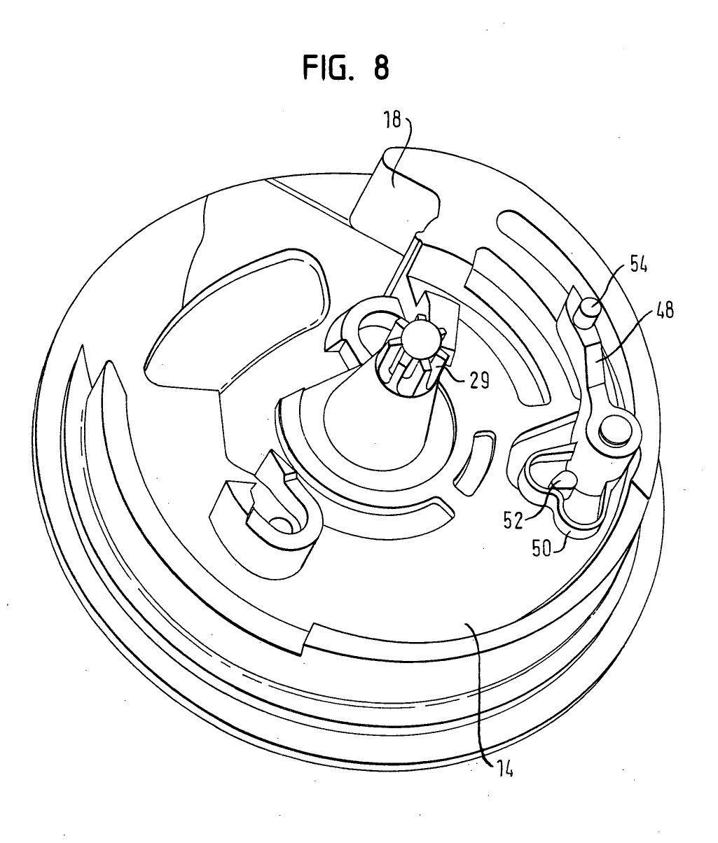

The locking mechanism on the other hand contains a bolt 48 (see in particular FIG. 8), which is mounted so as to be swivellable between an initial position and a locking position on the belt spool 12. The bolt 48 has a bistable detent mechanism, which is formed by a spring clip 50 having, in the broadest sense, a heart shape, which cooperates with a pin 52, which is constructed securely on the belt spool 14. In the centre, the spring clip 50 has an indentation which must slide over the pin 52 when the bolt 48 is transferred form the initial position into the locking position, and vice versa. This ensures that the bolt can not move inadvertently from one position into the other.

To move the bolt 48, a control pin 54 is provided at its free end, which cooperates with a link which is formed by two control ribs 56, 57 lying opposite each other, which are constructed on the locking lever 38 opposite the two guide pins 42, i.e. likewise at the end facing away from the locking extension 40.

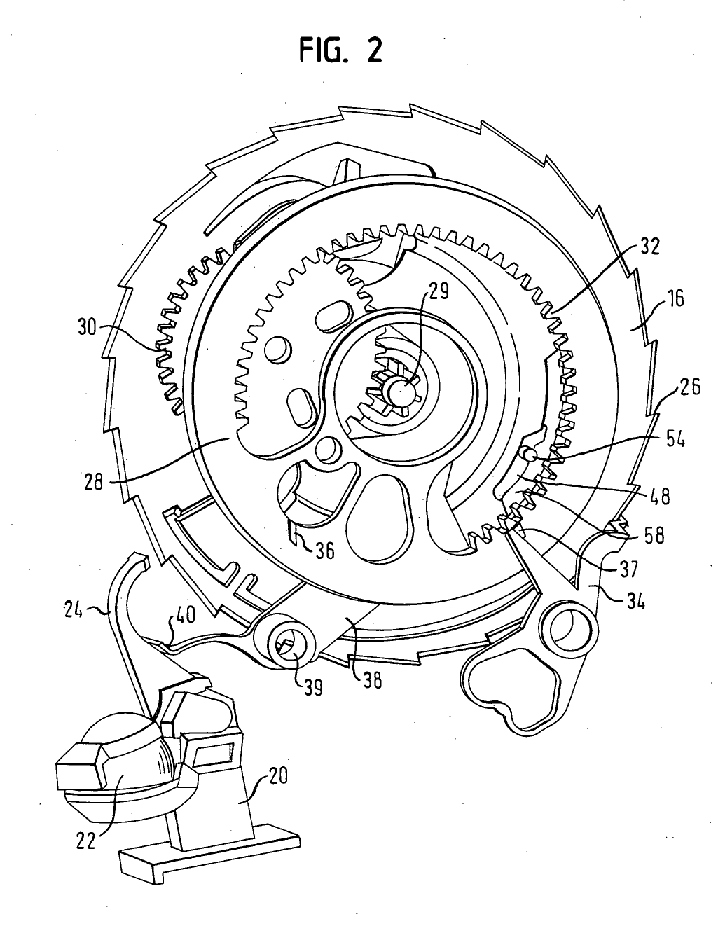

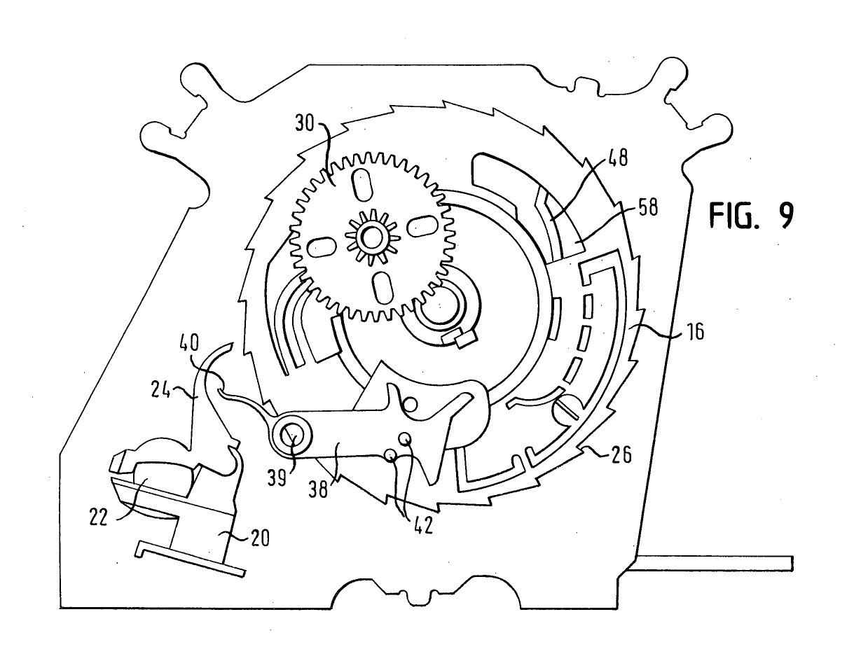

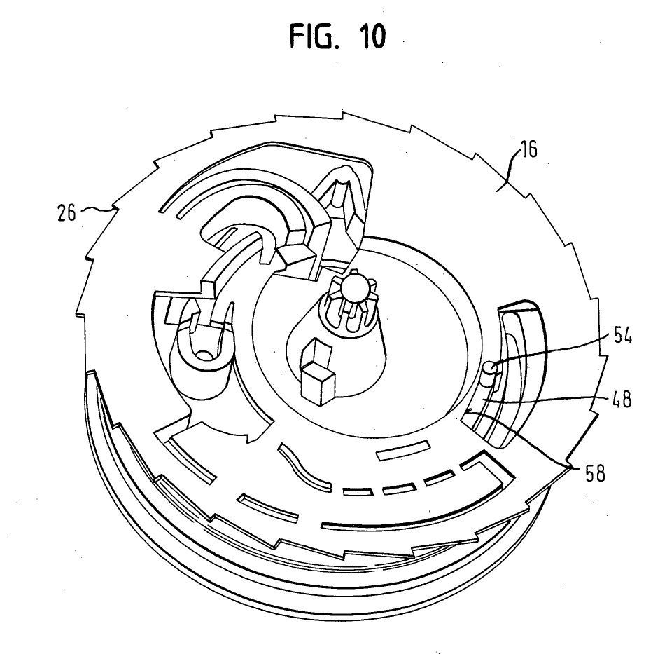

In the normal operation of the belt retractor, the bolt 48 is in the initial position shown in FIG. 9, in which it does not engage on the coupling disc 16. The coupling disc 16 can therefore turn relative to the belt spool 14, which is necessary for the guiding of the blocking catch. The control ribs 56, 57 are arranged so that the control pin 54 of the bolt 48, when the latter is in the initial position, can move through freely between the two control ribs when the locking lever 38 is likewise in its initial position, i.e. the sensor lever 24 is freed. When, on the other hand, the locking lever 38 is in its locking position, the control ribs 56, 57 are situated radially further inwards than in the initial position. As soon as the bolt 48, which turns together with the belt spool 14, reaches the two control ribs 56, 57 the next time on winding of the belt band, the control pin 54 is pressed radially inwards, whereby the bolt 48 is transferred from the initial position into its locking position (see in particular FIGS. 2 and 10). In this position, its free end engages into a window 58 of the coupling disc 16, so that the latter is locked so as to be secure against rotation relative to the belt spool 14. In this way it is prevented that the coupling disc, brought about for example by an abrupt braking of the belt spool 14, rotates relative to the latter and thereby causes the blocking mechanism to respond.

As soon as a specified length of the safety belt is unwound from the belt spool, firstly, brought about by the guide rib 44, the locking lever 38 is transferred from its locking position into the initial position. As soon as the bolt 48 together with its control pin 54 then passes the two control ribs 56, 57 of the locking lever 38 the next time, the control pin 54 is pressed radially outwards from the control ribs, whereby the bolt 48 is transferred into its initial position. Thereby, after the sensor 20 has firstly been freed again, the coupling disc 16 is also freed, so that the blocking mechanism can operate again as usual.

Through the positioning of the transition section 46 on the locking disc 28 with regard to angle, a setting can be made as to the length of the wound safety belt after which the usual finction of the blocking mechanism is prevented, i.e. firstly the sensor 20 and then the coupling disc 16 are inactivated.

According to a simplified embodiment of the invention, the bolt 48 is dispensed with.

1. A belt retractor for a vehicle safety belt, with a frame, a belt spool which can receive a safety belt and is arranged rotatably in said frame, and with a blocking mechanism by means of which said belt spool can be blocked against a rotation in a safety belt unwinding direction relative to said frame, said blocking mechanism containing a coupling disc which is rotatable relative to said belt spool, a locking mechanism being provided which locks a response of said blocking mechanism in a function range in which almost the entirety of said safety belt is wound on said belt spool.

2. The belt retractor according to claim 1, characterized in that said blocking mechanism has a vehicle-sensitive sensor with a sensor lever which can engage on said coupling disc, and wherein said locking mechanism when being activated locks said sensor lever so that it cannot engage on said coupling disc.

3. The belt retractor according to claim 2, characterized in that said locking mechanism has a locking lever which is swivellable between an initial position in which it does not engage on said sensor lever, and a locking position in which it locks said sensor lever.

4. The belt retractor according to claim 3, characterized in that said locking lever is arranged on said frame of said belt retractor.

5. The belt retractor according to claim 3, characterized in that said locking mechanism has a locking disc which is coupled with said belt spool by means of a reduction and as a function of a position swivels said locking lever between said initial position and said locking position.

6. The belt retractor according to claim 5, characterized in that said locking disc and said locking lever cooperate with each other by means of a connecting link guide.

7. The belt retractor according to claim 6, characterized in that said locking lever has two guide pins which engage on a guide rib on said locking disc.

8. The belt retractor according to claim 5, characterized in that a child safety mechanism is provided which can be actuated by said locking disc.

9. The belt retractor according to claim 1, characterized in that said locking mechanism, when it is activated, locks said coupling disc so as to be secure with regard to rotation with respect to said belt spool.

10. The belt retractor according to claim 9, characterized in that said locking mechanism has a bolt which is swivellable between an initial position in which it does not engage on said coupling disc, and a locking position in which said coupling disc is locked.

11. The belt retractor according to claim 10, characterized in that said bolt is arranged on said belt spool.

12. The belt retractor according to claim 10, characterized in that a bistable detent mechanism is provided which can hold said bolt in said initial position or in said locking position.

13. The belt retractor according to claim 12, characterized in that said detent mechanism has a spring clip which is constructed in one piece with said bolt and has a pin which is arranged on said belt spool.

14. The belt retractor according to claim 10, characterized in that said bolt has a control pin which cooperates with a link so that said bolt can be transferred from said initial position into said locking position.

15. The belt retractor according to claim 14, characterized in that said locking lever has a link which can engage on said control pin.

16. The belt retractor according to claim 15, characterized in that said link is formed by two control ribs lying opposite each other.
